(19) United States
(12) Patent Application Publication
(10) Pub. No.: US 2013/0019526 A1
(43) Pub. Date: Jan. 24, 2013

(54) PLANT POT

(71) Applicant: LIU-TSUN LAI, TAICHUNG CITY (TW)

(72) Inventor: LIU-TSUN LAI, TAICHUNG CITY (TW)

(21) Appl. No.: 13/188,585

(22) Filed: Jul. 22, 2011

(51) Int. Cl. A01G 9/02

(52) U.S. Cl. 47/81

(57) ABSTRACT

A plant pot includes a pot body having an upper chamber and a lower chamber defined therein and a plurality of front holes for growing plants, floriculture-planting materials set in the upper chamber, a water container set in the lower chamber, and a water absorption member partially dipped in the water in the water container and partially inserted into the floriculture-planting materials for transferring water from the water container to the floriculture-planting materials for growing plants.

### BACKGROUND OF THE INVENTION

1. Field of the Invention

The present invention relates to plant pots for growing plants and more particularly, to such a plant pot that automatically transfers water from a water container therein to the cultivated plants by means of a water absorption member.

2. Description of the Related Art

Plant pots include two types, one adapted for holding soil or floriculture-planting materials for cultivating non-aquatic plants, the other for holding water for cultivating aquatic plants. When cultivating plants in soil or floriculture-planting materials in a plant pot, the user needs to water the soil or floriculture-planting materials regularly. Further, a plant pot for cultivating aquatic plants is not suitable for cultivating non-aquatic plants.

### SUMMARY OF THE INVENTION

The present invention has been accomplished under the circumstances in view. It is therefore the main object of the present invention to provide a plant pot, which automatically transfers water from a water container therein to the cultivated plants by means of a water absorption member.

To achieve this and other objects of the present invention, a plant pot comprises a pot body having an upper chamber and a lower chamber defined therein and a plurality of front holes for growing plants, floriculture-planting materials set in the upper chamber, a water container set in the lower chamber, and a water absorption member partially dipped in the water in the water container and partially inserted into the floriculture-planting materials for transferring water from the water container to the floriculture-planting materials for growing plants.

### BRIEF DESCRIPTION OF THE DRAWINGS

FIG. 1 is an exploded view of a plant pot in accordance with the present invention.

FIG. 2 is a front view of plant pot in accordance with the present invention.

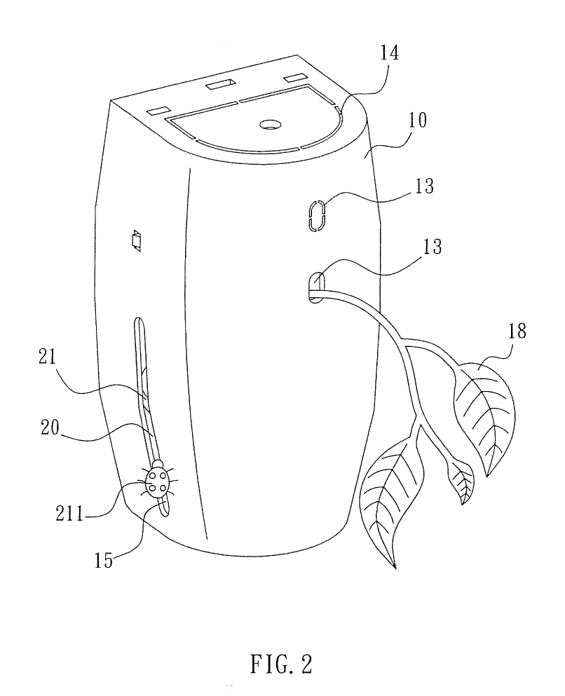

FIG. 3 is a sectional side of the present invention, illustrating an application example of the plant pot.

FIG. 4 is an oblique elevational view of the present invention, illustrating another application example of the plant pot.

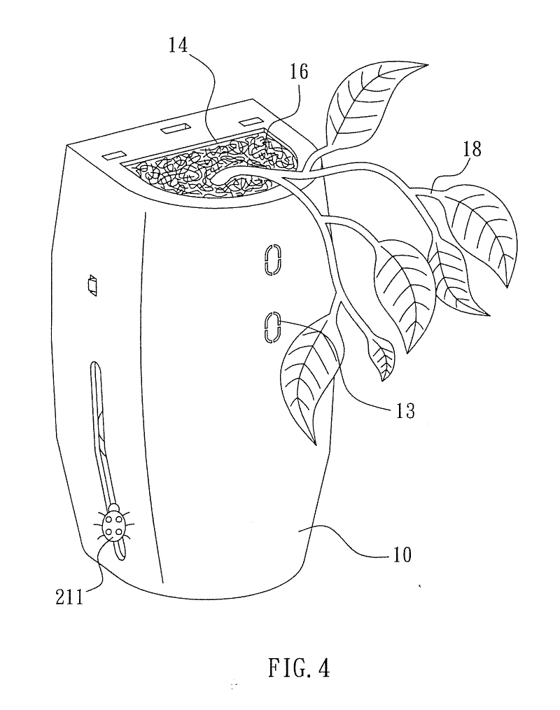

### DETAILED DESCRIPTION OF THE PREFERRED EMBODIMENT

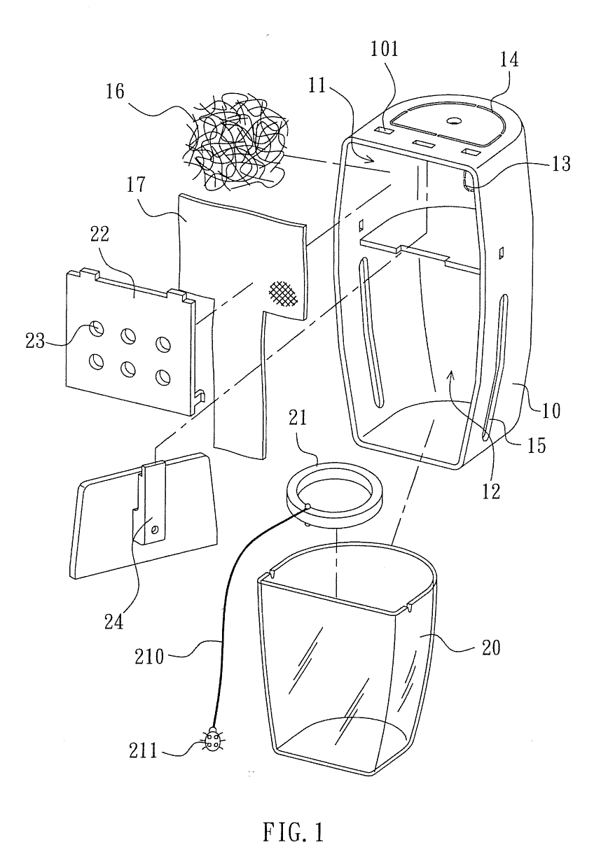

Referring to FIGS. 1˜4, a plant pot in accordance with the present invention is shown comprising a pot body 10, which has an upper chamber 11 and a lower chamber 12 defined therein, a plurality of front holes 13 located on the front side thereof, a top opening 14 and a mounting hole 101 located on the top side thereof and a longitudinal slot 15 located on one lateral side thereof, floriculture-planting materials 16 set in the upper chamber 11 of the pot body 10, a water container 20 set in the lower chamber 12 of the pot body 10 and holding a certain amount of water, a water absorption member 17 partially dipped in the water in the water container 20 in the upper chamber 11 of the pot body 10 and partially inserted into the floriculture-planting materials 16 in the upper chamber 11 of the pot body 10, a float 21 floating on the water in the water container 20, a cover plate 22, which is attached to the back open side of the pot body 10 to keep the floriculture-planting materials 16 in the upper chamber 11 and has air vents 23 for circulation of air, a hanger plate 24 fastenable to a wall for supporting the pot body 10 on the wall after hanging of the mounting hole 101 of the pot body 10 on the hanger plate 24, a cord member 210 having one end thereof connected to the float 21 and an opposite end thereof inserted through the longitudinal slot 15 to the outside of the pot body 10, and an index 211 connected to the distal end of the cord member 210 and suspending outside the pot body 10. Thus, the index 211 moves upwards or downwards relative to the pot body 10 subject to the condition of the water level of the water in the water container 20, i.e., the index 211 is indicated to the water level of the water in the water container 20.

Further, the water absorption member 17 can be prepared by absorptive cotton threads, cotton cloth or non-woven fabric. The floriculture-planting materials 16 can be selected from hydrophilic cotton balls, coconut fibers or culture soil.

Further, the lower chamber 12 of the pot body 10 can be configured for use as a water container for holding water. In this case, the aforesaid water container 20 can be omitted.

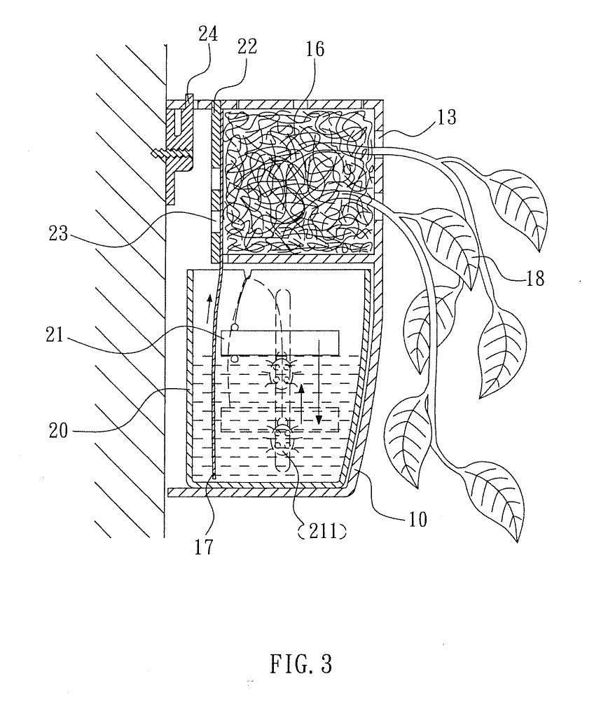

Based on the aforesaid arrangement, the plant pot of the present invention has the advantages and features as follows:
1. As illustrated in FIG. 3, the water absorption member 17 transfers water from the water container 20 to the plants 18 cultivated in the floriculture-planting materials 16. When the floriculture-planting materials 16 become dry, the water absorption member 17 immediately transfers water from the water container 20 to the floriculture-planting materials 16 for absorption by the plants 18. When the floriculture-planting materials 16 reach the saturated condition, the water absorption member 17 stops the transfer of water.
2. By means of the automatic water-transferring function of the water absorption member 17, it is not necessary to water the growing plants 18.
3. The cover plate 22 is detachable, facilitating replacement of the floriculture-planting materials 16. Further, the cover plate 22 has air vents 23 for circulation of air, enabling the growing plants 18 to breathe in fresh air.
4. The front holes 13 and top opening 14 of the pot body 10 facilitate growing plants.
5. The index 211 is movable along the longitudinal slot 15 of the pot body 10 subject to the condition of the water level of the water in the water container 20, so that the user can check the water level of the water in the water container 20 conveniently by eyes.
6. The floriculture-planting materials 16 and the water in the water container 20 are kept at different locations, facilitating growing aquatic plants and non-aquatic plants.
7. The pot body 10 can be placed on the tabletop, or hung on a wall by means of the hanger plate 24.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A plant pot, comprising:
a pot body comprising an upper chamber and a lower chamber defined therein, and a plurality of front holes located on a front side thereof for growing plants;
floriculture-planting materials set in said upper chamber of said pot body;
a water container set in said lower chamber of said pot body and adapted for holding water; and
a water absorption member partially dipped in the water in said water container and partially inserted into said floriculture-planting materials for transferring water from said water container to said floriculture-planting materials for growing plants.

2. The plant pot as claimed in claim 1, wherein said pot body has a cover plate attached to a back open side thereof and adapted for keeping said floriculture-planting materials in said upper chamber.

3. The plant pot as claimed in claim 1, wherein said pot body has a top opening located on a top side thereof for growing plants.

4. The plant pot as claimed in claim 1, further comprising a float floating on the water in said water container, a cord member connected to said float and extending to the outside of said pot body, and an index connected to a distal end of said cord member and suspending outside said pot body and movable vertically relative to said pot body with the water level of the water contained in said water container.
